(19) United States
(12) Patent Application Publication
(10) Pub. No.: US 2018/0084103 A1
(43) Pub. Date: Mar. 22, 2018

(54) SYSTEM AND METHOD FOR ACCESSING LOW LEVEL FUNCTIONS ON A MOBILE COMMUNICATION DEVICE

(71) Applicant: Go Point Technology, Inc., Troy, MI (US)

(72) Inventor: Brennan Todd Hamilton, Birmingham, MI (US)

(21) Appl. No.: 15/708,926

(22) Filed: Sep. 19, 2017

Related U.S. Application Data
(60) Provisional application No. 62/396,341, filed on Sep. 19, 2016.

(51) Int. Cl. H04M 1/725; H04W 12/08; H04W 4/04; G08G 1/052

(52) U.S. Cl. CPC H04M 1/72569; G08G 1/052; H04W 4/046; H04W 12/08

(57) ABSTRACT

An OBD2 device (safety device) monitors vehicle information such as vehicle speed, which vehicle information is electronically publishes and subscribed to by a safety monitoring application on a mobile communication device. The safety monitoring application determines when predetermined vehicle motion criteria have been meet and requests that the OBD2 device send a human interface device (HID) keyboard command to the mobile communication device, where the HID keyboard command is a screen lock command. The OBD2 device send the HID keyboard command to the mobile communication device which locks the screen of the mobile device.

### CROSS-REFERENCE TO RELATED APPLICATIONS

This application claims the benefit of U.S. provisional application No. 62/396,341, filed 19 Sep. 2016 (the '341 application). The '341 application is hereby incorporated by reference as though fully set forth herein.

### BACKGROUND

### a. Technical Field

The instant disclosure relates to a system and method for accessing low level functions on a mobile communication device.

### b. Background Art

This background description is set forth below for the purpose of providing context only. Therefore, any aspects of this background description, to the extent that it does not otherwise qualify as prior art, is neither expressly nor impliedly admitted as prior art against the instant disclosure.

It is known to provide a safety monitoring system that uses an on-board diagnostic-II (OBD2) device, hereinafter referred to as an OBD2 dongle, to read vehicle speed or acceleration information from an automotive vehicle to which it is connected and to interact with an application running on a mobile device to either allow or disallow (i.e., prohibit) certain activities, such as texting. One component of the system resides on the mobile device (i.e., a safety monitoring application) and another component of the system resides on the OBD2 dongle.

In such a system, when vehicle motion is detected, a “trigger” is sent to the mobile device and is read by the safety monitoring application. The safety monitoring application then “blocks” the use of mobile device applications. In this regard, blocking involves use of a “blocking screen”, which covers up the application that is not allowed. A blocking screen is used since the operating system of the mobile device does not allow applications—such as a safety monitoring application in this case—to access certain low level functions, such as locking the mobile device. However, the user of the mobile device remains able to navigate around the blocking screen or overlay.

The foregoing discussion is intended only to illustrate the present field and should not be taken as a disavowal of claim scope.

### SUMMARY

In an embodiment, a method for accessing a low level function on a mobile communication device is provided that includes obtaining, using an electronic component in communication with an automotive vehicle, predetermined vehicle information sufficient to determine whether the automotive vehicle is in motion. The method further includes sending, when the vehicle information indicates motion, a command from the electronic component to the mobile communication device configured to lock the device. In an embodiment, the method further includes electronically publishing the vehicle information and evaluating the vehicle information based on predetermined motion criteria and transmitting a request from the mobile communication device to the electronic component to send the command configured to lock the device. In an embodiment, the sending of the lock command from the electronic component may be performed by sending one or more human interface device (HID) keypresses selected to operate to lock the mobile communication device (e.g. only, for an iOS device, the selected keypress may be an HID_POWER keypress).

Methods involving an exclusionary zone and an event zone as well as an apparatus for accessing a low level function on a mobile communication device are also presented.

The foregoing and other aspects, features, details, utilities, and advantages of the present disclosure will be apparent from reading the following description and claims, and from reviewing the accompanying drawings.

### BRIEF DESCRIPTION OF THE DRAWINGS

FIG. 1 is diagrammatic and block diagram view of a system for accessing low level functions on a mobile communication device, in an embodiment.

FIG. 2 is a diagrammatic and block diagram view of a mobile communication device of the embodiment of FIG. 1 configured with a safety monitoring application.

FIG. 3 is a diagrammatic and block diagram view of the automotive vehicle of the embodiment of FIG. 1, including an OBD2 device for accessing vehicle information.

FIG. 4 is a block diagram view of the OBD2 device of FIG. 3 showing services performed including the HID keyboard service.

FIG. 5 is a simplified, flow chart diagram showing operation of the system of FIG. 1.

FIGS. 6-11 are screenshot views of the mobile communication device of FIG. 1 rendered from the point of view of the user of the device, in an embodiment.

### DETAILED DESCRIPTION

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

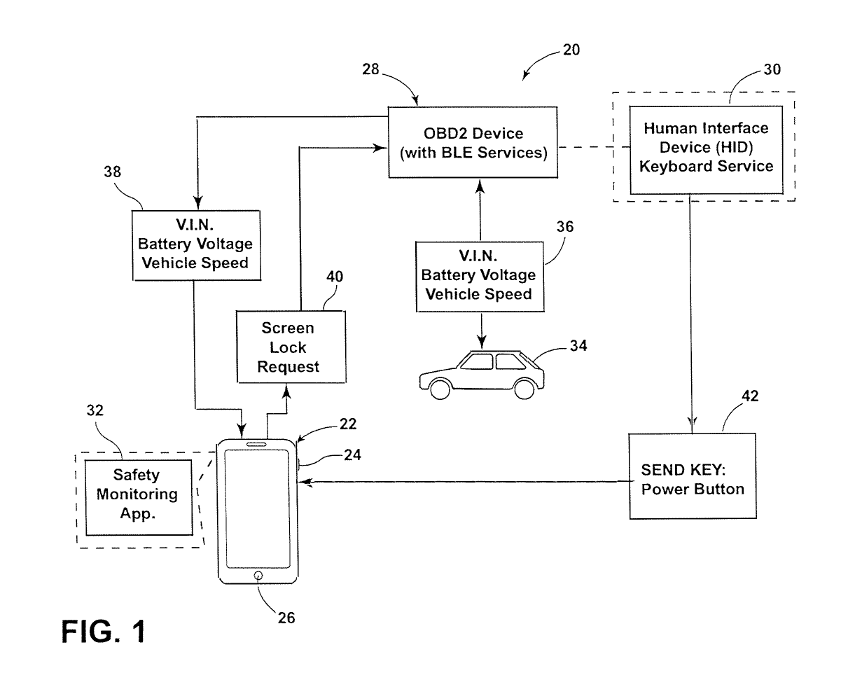

Referring now to the drawings wherein like reference numerals are used to identify identical or similar components in the various views, FIG. 1 is a diagrammatic and block diagram view of a system 20 for accessing low level functions on an electronic device, such as but not limited to a mobile communication device 22. As described in the Background, while third-party application programs (i.e., “apps”) can be installed on the mobile communication device 22, not all functions may be available to such apps, including low level functions such as access to (i) the power ON/OFF button/function 24, which can operate as a lock device command, and (ii) the HOME key 26, to mention a few.

Embodiments consistent with the instant teachings provide a system 20 that allows access to functions on a mobile communication device 22 that are generally not allowed. The system 20 includes two main components. A first component resides on a safety device, which may take the form in an embodiment of an OBD2 device 28, which first component includes in an embodiment at least a human interface device (HID) keyboard service 30. A second component includes, in an embodiment, a safety monitoring application program 32 (hereinafter the “safety monitoring app” 32), which resides on the mobile communication device 22.

In the illustrated embodiment, the system 20 can be configured to perform the function of a safety monitoring system that will lock the mobile communication device 22 when certain vehicle motion conditions of an automotive vehicle 34 are met (e.g., when vehicle speed exceeds zero, exceeds 5 MPH, etc.). Locking of the mobile communication device 22 prevents the user from using the device and thus also prevents the user from using the applications installed on the device, such as but not limited to a texting application. Blocking screens or overlays described in the Background can be circumvented (i.e., navigated around) by the user; however, a device lock prevents the user from using the device at all, in an embodiment, and eliminates the opportunity of defeating the block of the applications on the device.

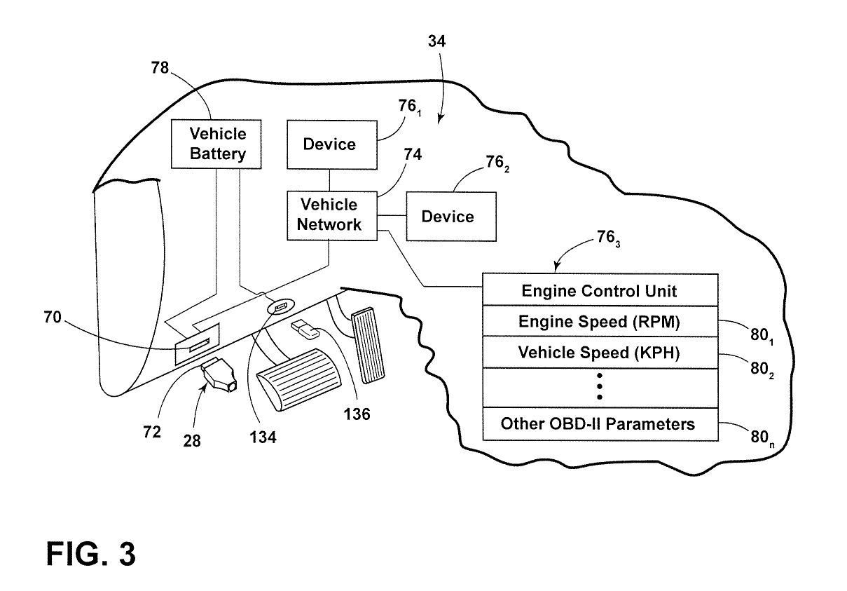

The following descriptions assumes that the safety device, namely the OBD2 device 28 in the illustrated embodiment, has been plugged into the vehicle OBD2 port (best shown FIG. 3) and that the safety monitoring app 32 has been installed on the mobile communication device 22. The safety device, namely, the OBD2 device 28 in the illustrated embodiment, via the first component monitors (e.g., periodically reads) predetermined vehicle information 36 from the automotive vehicle 34. As shown in FIG. 1, the predetermined vehicle information 36 may include but is not limited to a vehicle identification number (VIN), a battery voltage level, and a vehicle speed level. The OBD2 device 28 also electronically publishes the predetermined vehicle information at 38 for use by the safety monitoring app 32. As will be described below, in an embodiment, the publishing of the vehicle information may implemented using a Bluetooth low energy (BLE) service to which the mobile communication device 22 is connected.

The safety monitoring app 32 is configured to obtain the published vehicle information and to evaluate the vehicle information based on predetermined vehicle motion criteria (e.g., is the vehicle speed>zero, >5 MPH, etc.) to determine if conditions are satisfied to lock the screen (i.e., lock the mobile communication device 22). When the conditions are correct, the safety monitoring app 32 sends a request 40 destined for the OBD2 device 28 where the request 40 is to lock the screen/device 22. As described below, a service on the OBD2 device 28 receives the screen lock request 40 from the safety monitoring app 32 of the mobile communication device 22. The HID keyboard service 30, in response to the lock request 40, sends a keyboard command 42 (e.g., the keyboard command corresponding to the POWER button in an iOS embodiment). The mobile communication device 22 receives the HID keyboard command, for example, through an operating system keyboard input facility (i.e., low level drivers), which operates to lock the screen of the device 22.

It should be appreciated that conventional systems use an OBD2 device only as a trigger. In other words, the OBD2 device determines when the vehicle is in motion and then sends a trigger to the mobile device app which then executes a blocking screen. In embodiments of the instant teachings, however, the safety monitoring app 32 sends a lock request 40 to the OBD2 device 28 when predetermined vehicle motion criteria is met. The OBD2 device 28, via the HID keyboard service 30, then sends a screen lock (POWER button) command to the mobile communication device 22. In an alternative embodiment, the OBD2 device 28 may be configured to directly determine when the predetermined vehicle conditions have been met and then send the lock screen command (i.e., without receiving a lock screen request from the safety monitoring app 32).

An advantage of embodiments consistent with the instant disclosure provide access to low level functions (e.g., Application Programming Interface—API functions) that are normally disallowed to third-party applications, but are allowed through the use of the HID keyboard service. In other words, while the safety monitoring app 32 is not able to directly execute a command to lock the device screen, the app 32 can do so indirectly by requesting that the OBD2 device 28 lock the screen, which does so by sending a keyboard command via the HID keyboard service 30, which is recognized by the OS of the mobile device 22.

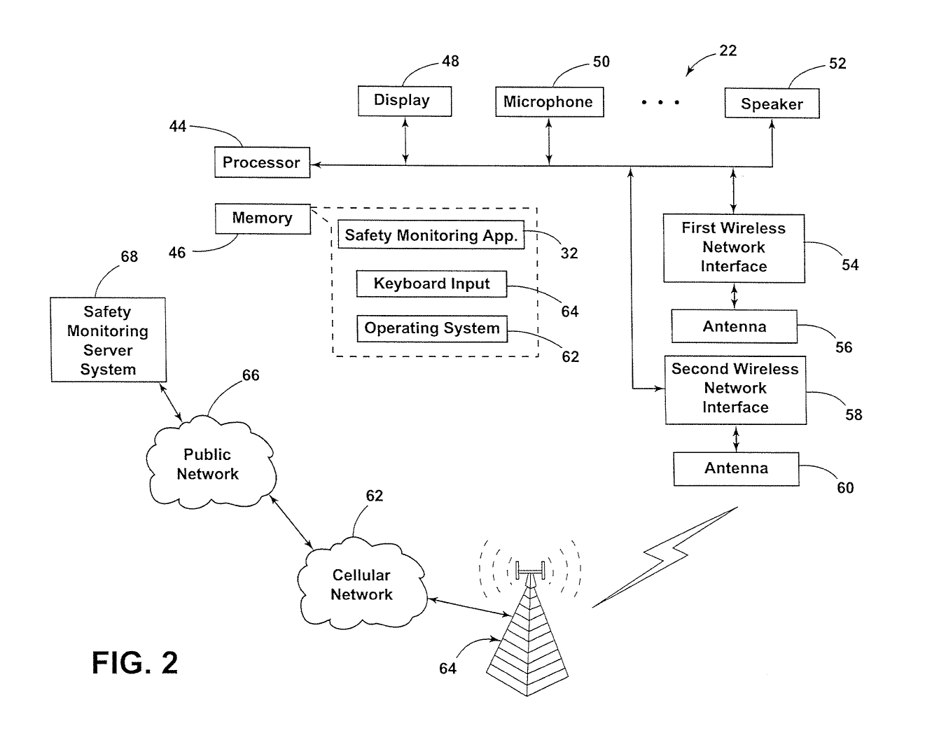

FIG. 2 is a diagrammatic and block diagram view showing mobile communication device 22 in greater detail. The mobile communication device 22 may include a cellular telephone (e.g., Smartphone) having safety monitoring functionality according to the teachings of the present disclosure. It should be understood, however, that mobile communication device 22 may include other electronic devices that can accept an HID keyboard command to be controlled, including but not limited to other types of cellular telephones, notebook computers, tablet computers, desktop computers, and the like.

In the illustrated embodiment, the mobile communication device 22 may include one or more processors 44, a memory 46, a variety of input/output mechanisms such as a display 48, a microphone 50 and a speaker 52, a first wireless network interface 54 and its associated antenna 56, and a second wireless network interface 58 and its associated antenna 60. The mobile communication device 22 may also include further components, such as a re-chargeable battery, signal processing circuitry and the like (not shown). Further, the mobile communication device 22 may include a power button 24 (best shown in FIG. 1) and a HOME button 26 (best shown in FIG. 1).

The processor 24 is configured generally to control the overall operation of mobile communication device 22, including coordination and cooperation among and between the other components of mobile communication device 22. For example, overall control may be achieved through execution by one or more processors 24 (only one shown) of a suitable mobile device operating system 62, which may include APPLE IOS operating system although it should be understood that the operating system 62 may include alternatives such as different versions of the GOOGLE ANDROID operating system, different versions of the MICROSOFT WINDOWS MOBILE operating system, and the like. As shown, the operating system 62 includes a facility (e.g., low level drivers) to receive as an input various HID keyboard commands, and this facility is designated as block 64.

Generally, for security reasons, the user device, namely, the mobile communication device 22, needs to securely pair with the safety device, such as the OBD2 device 28. It should be noted, however, that the safety device is not restricted to being an OBD2 device, and can comprise other electronic components—as described below. In an embodiment, an electronic component as the safety device can comprise a USB form factor. Further, such electronic components as the safety device can be embedded into any other device in the vehicle that is Bluetooth capable. In such an embodiment, no separate electronic component/safety device would be needed. For example, such electronic component/safety device can be embedded into an entertainment head unit.

Processor 44 may include one or more programmable electronic microprocessors or microcontrollers. In addition, processor 44 may include a central processing unit (CPU), memory (in addition to or such as the illustrated memory 46) and an input/output (I/O) interface through which processor 44 may receive a plurality of input signals including signals the first wireless network interface 54 and second wireless network interface 58. Such I/O interface is also configured to generate a plurality of output signals including but not limited to those used to control and/or provide data to display 48, speaker 50, and the first wireless network interface 54 and the second wireless network interface 58.

Memory 46 is provided for storage of data and instructions or code (i.e., software) for and readable and/or writable by processor 44. Memory 46 may include various forms of non-volatile (i.e., non-transitory) memory including flash memory or read only memory (ROM) including various forms of programmable read only memory (e.g., PROM, EPROM, EEPROM) and/or volatile memory including random access memory (RAM) including static random access memory (SRAM), dynamic random access memory (DRAM) and synchronous dynamic random access memory (SDRAM). Although illustrated as a separate component, memory 46 may be internal to the processor 44.

Display 48 functions as an input/output device for the user of the mobile communication device 22 and may include components known in the art. Display 48 may be, for example, a liquid crystal display or light emitting diode display or other technologies known in the art. Display 48 may function as only an output device with input received through other I/O devices such as a keyboard. Alternatively, display 48 may also function as an input device and may include a touch screen display including, for example, capacitive and resistive touch screen displays, or other technologies known in the art. Microphone 50 is an acoustic to electric transducer that converts sound or mechanical vibration to electrical signals. Speaker 52 is an electric to acoustic transducer that generates sound in response to electrical signals indicative of audio communications. Microphone 30 and speaker 32 may also be components known in the art.

The first wireless network interface 54 (including its associated antenna 56) is configured for establishing a connection between the mobile device 22 and a first network (not shown) and/or another device, and for this function may include a radio transceiver as known in the art. In an embodiment, the first wireless network interface 54 may be configured for short-range wireless communication, such as according to the Bluetooth Low Energy (BLE) standards. In an embodiment, the first wireless network interface may be configured for communication with the OBD2 device 28.

The second wireless network interface 58 (including its associated antenna 60) is configured to establish a connection to a second network 62 (e.g., cellular communications network which can be 2G/3G/4G), by way of base transceiver station 64. Cellular network 62 may connect to a network 66, which may be a public switched telephone network and/or the public Internet, in order to provide complete end-to-end voice and data communications capability between mobile communication device 22 and one or more external systems, such as a safety monitoring server system 68. In an embodiment, the safety monitoring server system 68 may be in communication with the safety monitoring app 32, for example, for accounting purposes (e.g., has either the mobile device 22 and/or OBD2 device 28 been previously associated with the vehicle 34). The VIN can be used to lock the device safety device to the vehicle, if desired. Additionally, the battery voltage reading may be used as a convenience for the user. In one embodiment, it is contemplated that if the safety device(s) were pre-installed in a vehicle, then dealership personnel could walk the parking lot and find which vehicles had low batteries, thus saving cost and warranty.

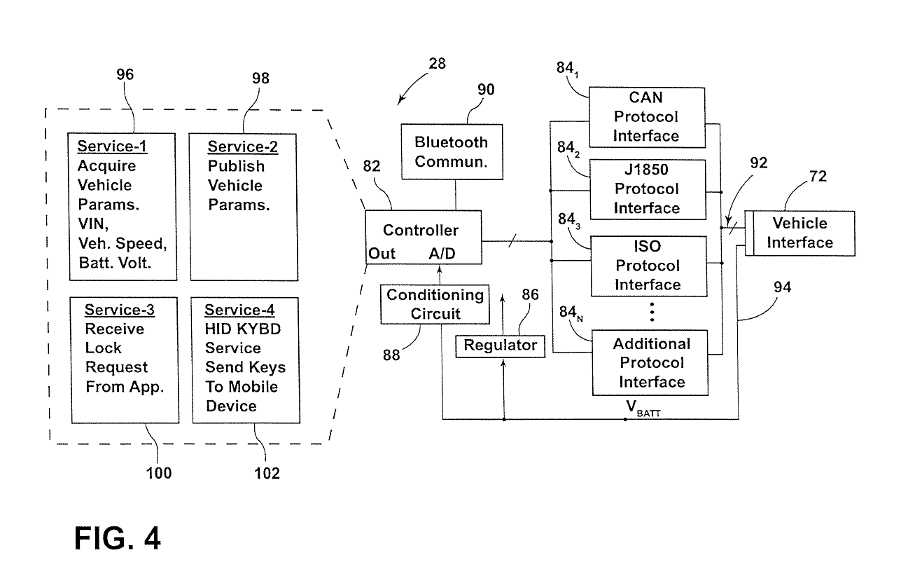

FIG. 2 further shows the safety monitoring app 32 in block form, which is configured to manage (i) obtain predetermined vehicle information 38 via subscription to various communication services described below in connection with FIG. 4), (ii), store predetermined vehicle motion criteria, (iii) evaluate the predetermined vehicle information in light of the predetermined vehicle motion criteria, and (iv) transmit a screen lock request to the electronic component/safety device, which in an embodiment is the OBD2 device 28, for example, using the first wireless network interface. The mobile communication device 22 may further include application programs stored in the memory 46 (i.e., code, software instructions, data) configured for execution by the processor 44 to achieve at least the above-identified safety monitoring functions of the app 32.

FIG. 3 is a partially broken away view of an interior cabin portion of the vehicle 34 in FIG. 1. The vehicle 34 includes a vehicle diagnostics port 70 (e.g., an OBD-II port) while the OBD2 device 28 includes a corresponding vehicle interface 72 configured to effect a mechanical and electrical connections to the vehicle 34 by way of the vehicle diagnostics port 70. The vehicle diagnostics port 70 is configured to provide access to a vehicle communications network 74 to which one or more electronic devices 76₁, 76₂, 76₃ may be connected. Through this OBD-II diagnostic port 70, access may be made directly to the vehicle's diagnostic and operating data stored therein, including an engine control unit 76₃. In an embodiment, the vehicle diagnostics port 70 comprises an on-board diagnostic (OBD-II) connector/interface, which is preferably a Society of Automotive Engineers (SAE) J1962 standard OBD-II diagnostic connector. Un-switched vehicle power (V_{BATT}) from a vehicle battery 78 is also provided on the diagnostics port 70, which may be a direct current (DC) voltage, typically around 12V when the engine is not running, and may be slightly greater than 14 volts when the engine is running (and thus while the vehicle generator is in operation).

Some vehicle parameters include the level of the vehicle battery (V_{BATT}), a current value of an engine speed (rpm) parameter 80₁ and a current value of a vehicle speed parameter 80₂. Current values for the latter two parameters may be stored as OBD-II diagnostic and operating data parameters in a powertrain controller, such as the ECU 76₃, which may also store additional OBD-II parameters 80ₙ. As described above, one or more of these parameters may be sent published as part of the vehicle information 36.

It should be understood that the electronic component/safety device, shown in the form of an OBD2 device 28, can take other forms in other embodiments. For example, the electronic component/safety device may comprise a USB Bluetooth device 136 configured to be inserted into a vehicle-supplied USB port 134. The port 134 can be a built-in USB port provided by the auto manufacturer or alternatively may be an USB power insert configured to be inserted into an accessory port (e.g., cigarette lighter receptacle or socket). The USB Bluetooth device 136 may be configured to perform services 100 and 102 described below.

FIG. 4 is a block diagram showing OBD2 device 28 in greater detail. The OBD2 device 28 may include an electronic controller 82, a plurality of protocol interface blocks 84₁, 84₂, 84₃, . . . 84ₙ, a voltage regulator 86 (for providing a regulated, known voltage), a conditioning circuit 88 (optional if raw battery voltage is needed), and a wireless communication block 90, which in an embodiment, comprises a Bluetooth low-energy communications block 90. FIG. 4 also shows, in block form, the vehicle interface 72. The vehicle interface 72 is configured to allow communications by the controller 82 through the diagnostic port 70 to the vehicle network 74 (FIG. 3) by way of a plurality of communication lines 92 and is also configured to receive a power signal 94 (e.g., V_{BATT}) from the diagnostic port 70.

The controller 82 is configured, generally, to (i) determine an appropriate communication protocol to use for communicating with the vehicle network 74; and (ii) render a plurality of services designated 96, 98, 100, and 102 in FIG. 4, as alluded to above in connection with FIG. 1 and which will be described in greater detail below. Determining the appropriate communication protocol may be accomplished in a conventional manner, as seen by reference to U.S. PG Pub. 2012-0215396 entitled “SYSTEM AND METHOD FOR EMULATING VEHICLE IGNITION-SWITCHED POWER” hereby incorporated by reference as though fully set forth herein. The controller 82 may also configured to measure the vehicle battery level V_{BATT}. The controller 82 may comprise a conventional micro-controller having at least one microprocessor or other processing unit, associated and/or integrated memory devices such as read only memory (ROM) and random access memory (RAM), a timing clock or input therefore, input capability for monitoring input from external analog and digital devices or signals, such as an analog-to-digital input, and output capability for generating an output signal for controlling output devices, for example. The controller 82 and/or Bluetooth block 90 may comprise conventional computing apparatus known to those of ordinary skill in the art, and be configured to execute pre-programmed software instructions (code, including data) stored in an associated memory to perform in accordance with the functions described herein, including at least the services 96, 98, 100, and 102 described herein. It is thus contemplated that the processes described herein will be programmed with the resulting software code being stored in the associated memory.

Services 98, 100, and 102 may be implemented using Bluetooth communication technology. In this regard, the OBD2 device 28 may use a 128-bit UUID (Universally Unique Identifier) to identify these various services (e.g., emanating from the OBD2 device 28), as set forth in the International Telecommunication Union document ITU-T X.667, Series X: Data Networks and Open System Communications, OSI Networking and system aspects—Naming, Addressing and Registration, hereby incorporated by reference as though fully set forth herein, and available at http://www.itu.int/ITU-T/studygroups/com17/oid/X.667-E.pdf. Generating a unique UUID is known in the art. For example, a publicly available tool can generate a unique UUID, which can be found at http://www.itu.int/en/ITU-T/asn1/Pages/UUID/uuids.aspx, which document and tool is hereby incorporated by reference as though fully set forth herein.

The Bluetooth specification states that 16 bit and 32 bit UUIDs calculated off of the base Bluetooth UUID of 00000000-0000-1000-8000-00805F9B34FB are reserved. UUIDs outside of these base services are available to use (see for example, the document entitled Bluetooth Service Discovery, Service Discovery Protocol (SDP), available at https://www.bluetooth.com/specifications/assigned-numbers/service-discovery), which is hereby incorporated by reference as through fully set forth herein. For example, base services can include heart rate monitors, battery monitors, etc.

The basic method involves the safety monitoring app 32 looking for the custom service(s) published by the OBD2 device 28, pulls/subscribes to the services to obtain, e.g., vehicle speed to determine motion, when criteria is met confirming motion of the vehicle, the app 32 writes to the HID service 102 (keyboard service), and then the HID keyboard service 102 (in the OBD2 device 28) sends HID key or sequence of HID keys (e.g., HID_POWER key) to the mobile communication device 28 to lock it.

In an embodiment, the HID key is sent to the mobile communication device 28 that is paired with the OBD2 device 28, and thus in this embodiment, whichever app 32 pairs first with the OBD2 device 28 can be locked. Alternatively, the OBD2 device 28 may be configured to select the particular mobile communication device 22 to which the HID key is to be sent based on a signal strength, rather than a formal pairing.

Service 96. The first service 96 is configured to acquire one or more vehicle parameters or other information from, for example, the vehicle network 74. The one or more vehicle parameters or information corresponds to the vehicle information 36 (FIG. 1), including but not limited to vehicle identification number (VIN), vehicle speed, vehicle battery voltage (Volts), and the like. Service 96 executing on the controller 82 may comprise conventional read requests to the vehicle network 74, in accordance with OBD-II protocols. In other embodiments, this service 96 may be performed by other electronic components as described below, such as a discrete GPS or built-in GPS in the mobile device 22 (or tablet).

Service 98. The second service 98 is configured to publish the vehicle information 36 described above and therefore make it available to the safety monitoring app 32. In an embodiment, the vehicle information 36 is published by the OBD2 device 28 using Bluetooth low energy (BLE) communication technology as described in greater detail herein. In other embodiments, this service 98 may be formed by other electronic components described below, such as a discrete or embedded device or the mobile device 22 (or tablet) itself

Service 100. The third service 100 is configured to receive a lock request from the safety monitoring app 32. In an embodiment, the lock request is communicated from the safety monitoring app 32 to the OBD2 device 28 according to Bluetooth low energy (BLE) communication technology as described in greater detail herein. In other embodiments, this service 100 may be performed by other electronic components described below, such as a Bluetooth 4.0 dongle 136 (FIG. 3).

Service 102. The fourth service 102 is configured to send a human interface device (HID) keyboard command from the OBD2 device 28 to the mobile communication device 22, which is received by an operating system component keyboard input 64 (FIG. 2). A keyboard service rendered in an embodiment described herein can constitute a device that can be compliant with a so-called Human Interface Device (HID) specification, as known in the art. The OBD2 device 28 publishes an HID keyboard service as a standard Bluetooth service as described herein. Additional services described above published by the OBD2 device 28 may comprise custom services. The following publicly available, published document entitled Universal Serial Bus (USB), Device Class Definition for Human Interface Devices (HID), version 1.11, available at www.usb.org/developers/hidpage/HID1_11.pdf is hereby incorporated by reference as though fully set forth herein. In this regard, an embodiment described herein renders an HID keyboard service 102 for the purpose of sending HID keyboard keypresses to the mobile communication device 22. In the embodiment described herein, a conventional HID_Power key will be sent to the mobile communication device 22.

In other embodiments, this service 102 may be performed by other electronic components described below, such as a Bluetooth 4.0 dongle 136 (FIG. 3).

Additionally, the HID keyboard service 102, in an embodiment, can be rendered in accordance with HID usage tables, for example only, the HID keyboard usage codes defined in the USB standards, more specifically set forth in the Consumer Page (0x0C) (i.e., consumer reports 0x0C). In an embodiment, the HID keyboard service 102 is configured to send an HID_Power keypress (usage ID 0x30) when a screen lock request 40 is received. The following publicly available, published document entitled Universal Serial Bus (USB), HID Usage Tables, version 1.12, is hereby incorporated by reference as though fully set forth herein, and is available at www.usb.org/developers/hidpage/Hut1_12v2.pdf.

It should be appreciated that the HID_Power keypress acts to lock the screen where the mobile communication device 22 runs an Apple iOS operating system. However, it should be understand that any valid HID keypress can be sent by the HID keyboard service 102 rendered according to an embodiment.

As described above, an embodiment uses the HID Consumer Keys. These are the valid Consumer Keys for iOS, an operating system used for mobile devices manufactured by Apple Inc., Cupertino, Calif., USA. For reference, the HID keyboard service 102 sends the 0x0030 key to the mobile communications device 22 (e.g., iOS device such as iPhone), which iOS interprets as a lock/power keypress on the device, which locks the screen on the device. The HID keyboard service 102 could also send a sequence of HID keyboard keypresses, such as the sequence of Home+passcode to unlock the device (e.g., an iPhone/iPod touch/iPad, in the case of an iOS device). For example only, if the passcode for the device was 1234, the HID keyboard service 102 could be configured to send the following sequence of keypresses to the iOS device, HOME-1-2-3-4 in order to unlock the device.

In another embodiment, the safety monitoring app 32 may be configured to determine when device is no longer in motion (e.g., when the vehicle 34 in which the mobile communication device 22 is located has stopped at a traffic light), and then request that the HID keyboard service 102 unlock the mobile communication device 22, which the HID keyboard service 102 does by sending the HID keyboard key sequence Home+passcode as described above. The tables below show other common possible HID keyboard keypresses that can be sent by the HID keyboard service 102 described herein.

TABLE 1
USB HID Consumer Page Controls Supported by iOS

| HID Usage ID | HID Usage Name | iOS Function |
|---|---|---|
| 0x0030 | Power | Lock |
| 0x0040 | Menu | Home |
| 0x00B5 | Scan Next Track | Transport Right |
| 0x00B6 | Scan Previous Track | Transport Left |
| 0x00CD | Play/Pause | Play/Pause |
| 0x00E2 | Mute | Mute |
| 0x00E9 | Volume Increment | Louder |
| 0x00EA | Volume Decrement | Softer |

TABLE 2
Lingo 0x02: Simple Remote Lingo (Additional Lingoes)

| HID Usage ID | HDD Usage Name | iOS Function |
|---|---|---|
| 0x01AE | AL Keyboard Layout | Toggle Onscreen Keyboard |
| 0x01B1 | AL Screen Saver | Picture Frame |
| 0x0221 | AO Search | Spotlight |

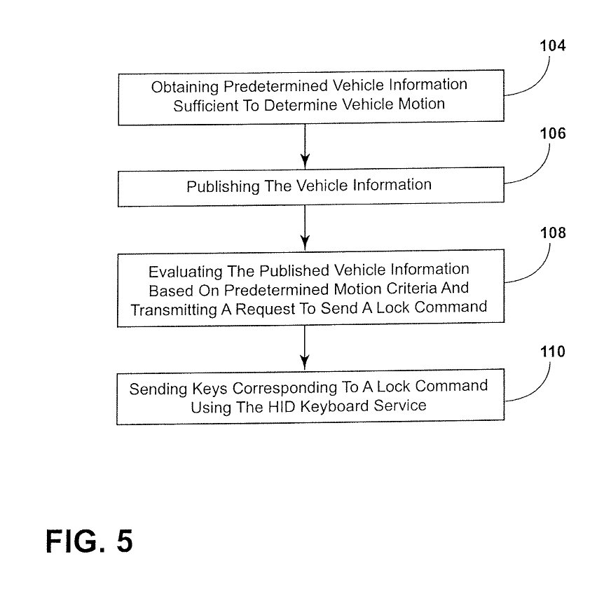

FIG. 5 is a simplified flowchart illustrating the method for accessing low level functions on a mobile communications device 28. The method begins in step 104.

Step 104 involves obtaining predetermined vehicle information sufficient to determine vehicle motion. As described above, this may be vehicle information 36 may include at least one of but not limited to vehicle identification number (VIN), vehicle speed, vehicle battery voltage, and the like. The method proceeds to step 106.

Step 106 involves publishing the vehicle information 36. As described above, this step may be performed using Bluetooth communication technology. The method proceeds to step 108.

Step 108 involves evaluating, in the safety monitoring app 32, the published vehicle information based on predetermined motion criteria and transmitting a request to the OBD2 device 28 to send a screen lock command (HID keypress command as described above). In an embodiment, the predetermined motion criteria is selected to constitute the vehicle speed. In an embodiment, the level of the vehicle speed at which the lock in the mobile communication device 22 occurs is calibrate-able. In an embodiment, the vehicle speed may be about 5 miles per hour (MPH), with hysteresis to avoid unnecessary locks. With the OBD2 device 28 embodiment, the vehicle speed comes from the vehicle itself, as described above. In a USB version described herein, the vehicle speed may come from the user's mobile communication device (i.e., a GPS navigation speed).

Step 110 involves the OBD2 device 28 sending the requested HID keyboard command (POWER command) to the mobile communication device 28 in order to lock the screen. It should be understood that the HID keyboard command(s) are processed by the low-level drivers of the operating system of the mobile communication device 22 (e.g., FIG. 2, block 64). The safety monitoring app 32 sees the result of the lock command through a status notification from the OS, but not the keyboard command itself

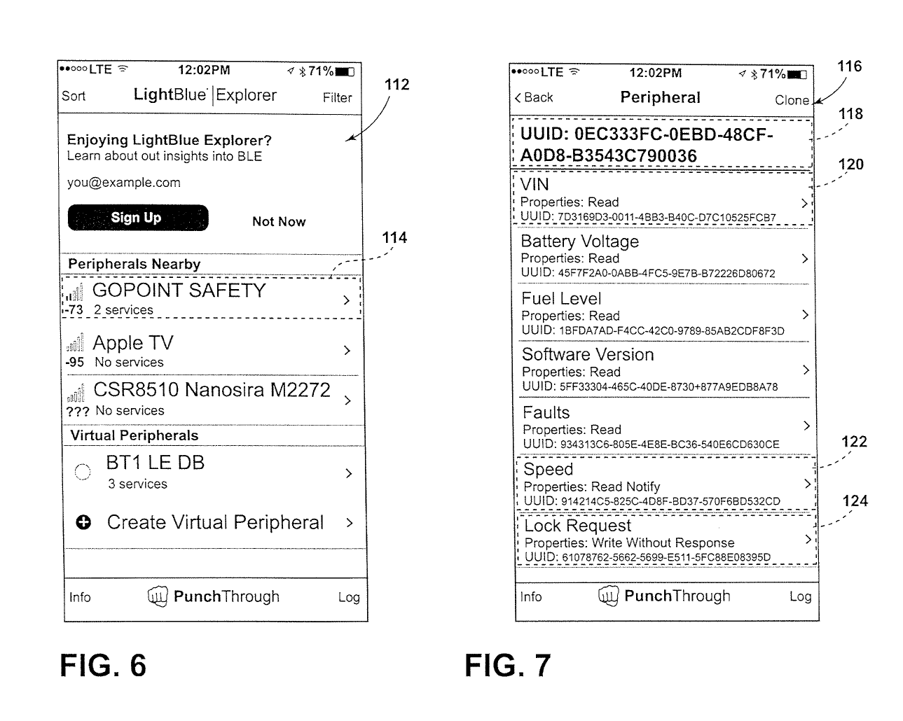

FIGS. 6-11 are screenshots depicting operation of an embodiment from the perspective of a user of the safety monitoring app 32.

FIG. 6 shows the screen of the mobile communication device 22, in particular, the availability to connect to the OBD2 device 28 (identified as “GOPOINT SAFETY” device). It should be noted that the OBD2 device 28 has associated therewith a plurality of services.

FIG. 7 shows the screen of the mobile communication device 22 after selecting the OBD2 device 28 (“GOPOINT SAFETY”). The custom 128-bit UUID service is identified, which is available to the safety monitoring app 32 on the mobile device 22. Also note main characteristics are “Speed” and “Lock Request”.

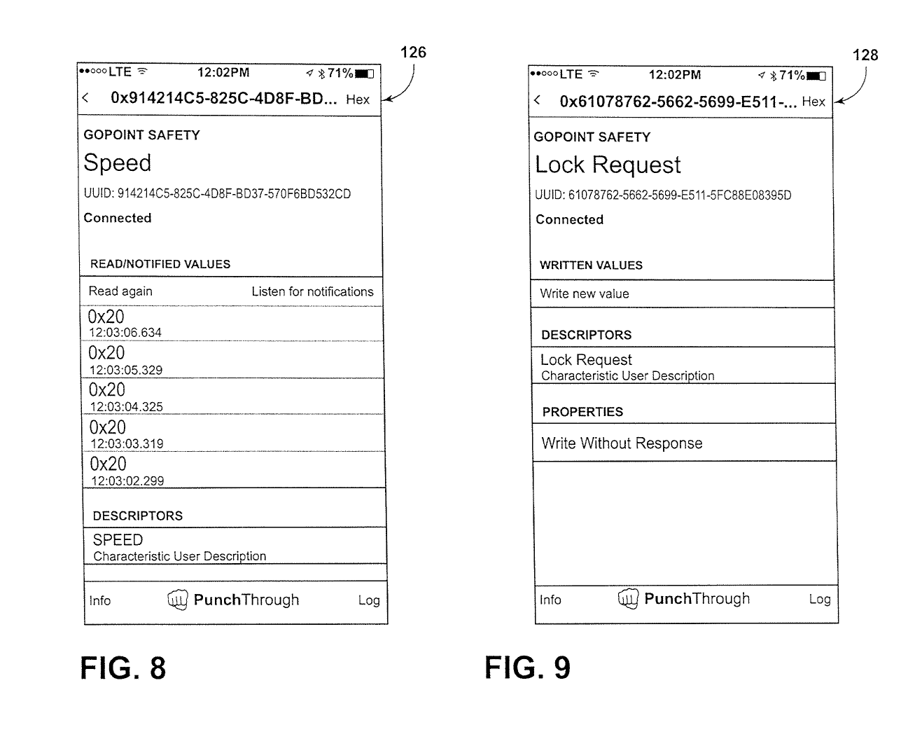

FIG. 8 shows the screen of the mobile communication device 22 for the “Speed” characteristic, which is read/notify. Note that the user has subscribed to (vehicle) speed updates “Listen for notifications”.

FIG. 9 shows the screen of the mobile communication device 22 for the “Lock Request” characteristic which is “Write Without Response.” In an embodiment, when any value is written to it, that will be considered a request to the OBD2 device to send an HID keyboard command (i.e., the lock screen command).

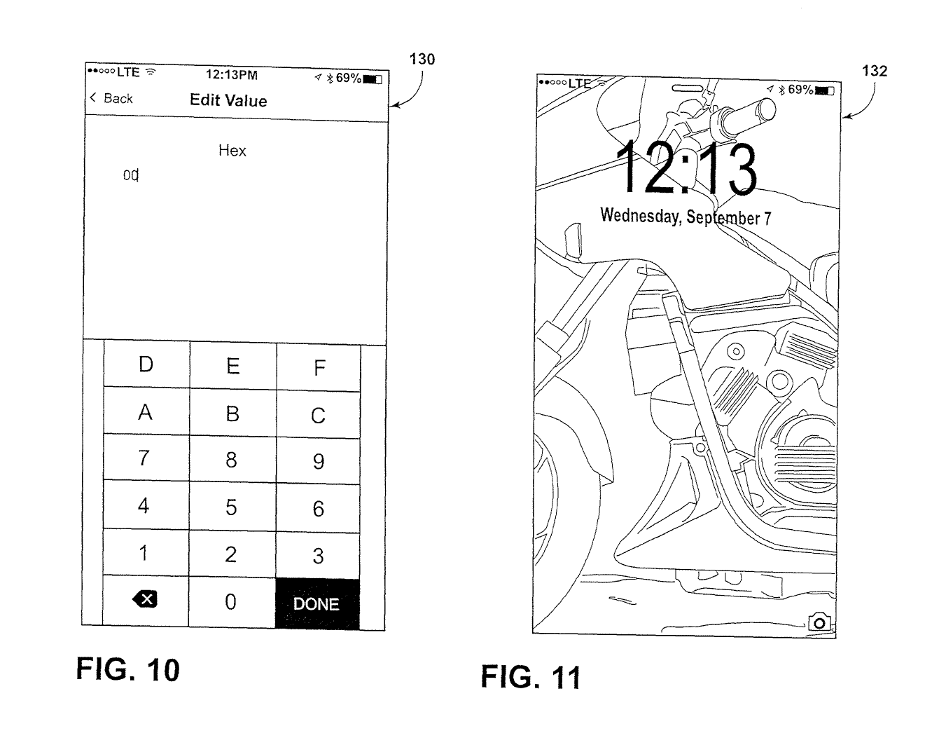

FIG. 10 shows the screen of the mobile communication device 22. As noted above, when any value is written to the Lock Request, that act is considered a Request to the OBD2 device 28 to send a lock screen command. In the illustrative FIG. 10, a value of 0x00 is written to the Lock Request characteristic. In an embodiment, this act would be done by the safety monitoring app 32 when the predetermined vehicle motion conditions have been determined to have been met.

FIG. 11 shows the screen of the mobile communication device 22. As a result of the value written to the Lock Request characteristic, the OBD2 device 28, specifically the HID keyboard service 102, sends the lock screen command (i.e., HID_POWER key). As a result, the screen of the mobile device 22 (i.e., the device 22) is now locked.

Further Embodiments. In a further embodiment, the HID keyboard service may be configured to send a sequence of keypress(es) corresponding to a push notification to the mobile communication device 22 in order to unlock it. For example, assume that a user is driving a truck belonging to a company for whom the user works. The company policy states that the driver of company truck—the user—cannot use a mobile communication device/cellphone while driving. In an example, the user pulls over and parks the company truck. The previously-described interactions between a safety monitoring app 32 and the OBD2 device 28 services (i.e., including the HID keyboard services 102) can determine that the truck is no longer in motion and then send a push notification to the safety app 32 to unlock the mobile device 22. The HID keyboard service 102 via a Bluetooth low energy (BLE) connection sends a keypress sequence HOME-1-2-3-4 and unlocks the mobile device/phone 22, thereby allowing the user to then use the device/phone 22.

In the above example, further assume that the user does not even know what the passcode is for the device (e.g., a strategy so as to avoid user temptation to use the device—phone or tablet—while driving). In this further example, the device (phone/tablet) might be permanently mounted to the vehicle. Functionality (i.e., unlocking the device for use) might only be available when the vehicle is not in motion, as determined herein. For example, such a strategy may be useful for fleet management systems, delivery verification systems, etc.

Phones and tablets are not the only devices that can be controlled by embodiments consistent with the instant teachings. Any electronic devices that accept HID keyboard commands can be controlled, such as phones, tablets, laptops, desktops, etc. In an embodiment, it is possible to create an exclusionary zone, where the use of such electronic device is prohibited (e.g., the HID keyboard service will send out the HID_Power key to such devices to lock them and prevent use).

In another example, an embodiment of the instant teachings may be applied to manufacturing. Assume that you have a manufacturing operation that is hazardous/dangerous. In an embodiment, an iBeacon solution including OBD2 hardware plus the user safety monitoring app 32, could be put in place to prohibit the use of an electronic device (e.g., device 22). For example, when the press operator is near a stamping press, the worker's mobile device/phone is disabled from being used (i.e., the system locks the screen, in a manner described above). As a further example, when a worker is in a solvents area, the worker's device/phone is again disabled from being used by the same approach described above. As a still further example, when an airport worker is out on the tarmac working, such as on an airplane, the worker's device/phone is disabled from being used (i.e., the system locks the screen, in a manner described above).

Broadly speaking, an automotive vehicle (car) may be considered just one of a plurality of possible exclusionary zones. Other exclusionary zones may include without limitation:

Classroom

Airport tarmac

Life guard stand

Refueling depot

Court room

Locker room

Board room

Aircraft carrier flight deck

Hospital operating room.

In a still further embodiment, assume that a company proprietor is having a big reveal of a new widget. However, the proprietor does not want any video or pictures taken of the widget or at the event. Instead of an exclusionary zone, an embodiment of the present teachings can be used to you create an event zone, where only certain functions are allowed or disallowed, as the case may be. For example, the following description outlines a possible implementation showing how an event zone may be created and deployed.

First, an iBeacon type arrangement can be (as described above) can be setup at the event venue.

Second, participants download and run an app upon entering the venue (e.g., scan a QR code, barcode, etc.). In this regard, a QR code or barcode is scanned that designates the event and describes the permissions given to the downloaded app, for example only listed below:

No video

No Audio

No Photograph

Yes texting

Yes note taking

Yes emailing.

If the participant attempts to navigate away from the downloaded app (not shown) to take a picture, the phone/tablet locks the device, as described above (i.e., by using sending the lock screen command, for example, HID_POWER key). Thus, embodiments of the present teachings in this example can be used to (1) create an event zone and (2) the zone includes restrictions. All allowed functions are served through the downloaded app which is provided by or through the event proprietor to the participants. The app enforces the restrictions, for example only, in that attempting to navigate away from the app causes the phone/tablet/computer to be locked and thus disabled. Additionally, the app may be configured to log such an occurrence as an infraction. In a further embodiment, a user attempt to kill the app (i.e., to circumvent the restrictions enforced by the app) may also be logged as an infraction. Likewise, terminating the Bluetooth connection may also be logged as an infraction.

It should be understood that variations are possible. While speed information is obtained from the OBD2 device 28, in an embodiment, in alternate embodiments, vehicle speed information can be obtained from alternate sources, such GPS devices (e.g., built-in the device/phone or external thereto). More generally, because the embodiments is broken into services, each service may be aggregated or separated from the OBD2 device 28.

Service 96 (vehicle information 36): The service that obtains information from an automotive vehicle 34 such as vehicle speed, VIN, etc. This may be provided by the OBD2 device 28 as described above, a discrete GPS receiver, or a GPS receiver that is embedded in the mobile communication device 22 or a tablet being monitored.

Service 98: The service that publishes the vehicle data for use by the mobile device 22 safety monitoring app 32. This service may be provided by a discrete or embedded device or the mobile communication device 22 or tablet itself.

Service 100: The service on the OBD2 device 28 that receives the screen lock request from the mobile safety monitoring app 32. This service may be provided by a discrete or embedded device or the mobile communication device 28 or tablet itself.

Service 102: The HID keyboard service on the OBD2 device that sends standard HID keyboard codes over a wireless connection to the mobile communication device 22. This service may be provided by a discrete or embedded device or the mobile communication device 22 or tablet itself.

In an embodiment, the OBD2 device 28 provides services 96, 98, 100, and 102, for example, as described above.

In another embodiment, the OBD2 device 28 provides services 96 and 98, while a Bluetooth 4.0 USB dongle (e.g., as shown in FIG. 3—dongle 136) can provide services 100 and 102.

In a still further embodiment, the hardware and operating system of the mobile communication device 22 can provides services 96 and 98 while a Bluetooth 4.0 USB dongle (e.g., device 136—FIG. 3) provides services 100 and 102.

The Bluetooth 4.0 USB dongle described above (e.g., FIG. 3—item 136) may be a device that can be inserted into a cigarette lighter socket in the vehicle for powering purposes. Alternatively, embodiments consistent with the present teachings may make use of any pre-existing facilities already present in the vehicle.

It should be understood that one or more of the processors and/or controller as described herein may include conventional processing apparatus known in the art, capable of executing pre-programmed instructions stored in an associated memory, all performing in accordance with the functionality described herein. To the extent that the methods described herein are embodied in software, the resulting software can be stored in an associated memory and can also constitute the means for performing such methods. Implementation of certain embodiments, where done so in software, would require no more than routine application of programming skills by one of ordinary skill in the art, in view of the foregoing enabling description. Such an electronic control unit may further be of the type having both ROM, RAM, a combination of non-volatile and volatile (modifiable) memory so that any software may be stored and yet allow storage and processing of dynamically produced data and/or signals.

It should be further understood that an article of manufacture in accordance with this disclosure includes a computer-readable storage medium having a computer program encoded thereon for implementing the logic for accessing low level mobile device functions and other functionality described herein. The computer program includes code to perform one or more of the methods disclosed herein. Such embodiments may be configured to execute one or more processors, multiple processors that are integrated into a single system or are distributed over and connected together through a communications network, and where the network may be wired or wireless.

Although only certain embodiments have been described above with a certain degree of particularity, those skilled in the art could make numerous alterations to the disclosed embodiments without departing from the scope of this disclosure. All directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments. Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. Additionally, the terms “electrically connected” and “in communication” are meant to be construed broadly to encompass both wired and wireless connections and communications. It is intended that all matter contained in the above description or shown in the accompanying drawings shall be interpreted as illustrative only and not limiting. Changes in detail or structure may be made without departing from the invention as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

While one or more particular embodiments have been shown and described, it will be understood by those of skill in the art that various changes and modifications can be made without departing from the spirit and scope of the present teachings.

What is claimed is:

1. A method for accessing a low level function on a mobile communication device, comprising:
obtaining, using an electronic component in communication with an automotive vehicle, predetermined vehicle information sufficient to determine whether the automotive vehicle is in motion; and
sending, when the vehicle information indicates motion, a command from the electronic component to the mobile communication device configured to lock the device.

2. The method of claim 1 further comprising:
electronically publishing the vehicle information sufficient to determine vehicle motion;
evaluating the vehicle information based on predetermined motion criteria and transmitting a request from the mobile communication device to the electronic component to send the command configured to lock the device.

3. The method of claim 2 further comprising:
receiving, at the electronic component, the request to send the command to lock the mobile communication device; and
sending, from the electronic component, a human interface device (HID) keypress selected to operate to lock the mobile communication device.

4. The method of claim 3 wherein the mobile communication device comprises an iOS device and wherein the method further comprises:
selecting the HID keypress to be an HID_POWER keypress.

5. The method of claim 1 wherein the electronic component comprises an On Board Diagnostic-II (OBD2) compliant device.

6. The method of claim 1 wherein the electronic component comprises a discrete global positioning system (GPS) device.

7. The method of claim 1 wherein the electronic component comprises a global positioning system (GPS) facility in the mobile communication device.

8. The method of claim 2 wherein evaluating and transmitting is performed by a safety monitoring application executing on the mobile communication device.

9. The method of claim 3 further comprising:
receiving the HID keypress command at the mobile communication device through an operating system keyboard input facility.

10. The method of claim 3 wherein the electronic component comprises a Bluetooth 4.0 USB dongle configured to perform the receiving of the request to send the command to lock the mobile communication device and the sending of the HID keypress configured to lock the mobile communication device.

11. The method of claim 1 wherein the electronic component and the mobile communication device are paired according to Bluetooth pairing protocol.

12. The method of claim 11 wherein the sending of the lock command is directed to only the paired mobile communication device.

13. The method of claim 12 wherein the mobile communication device is a first mobile communication device in proximity to said electronic component, and further comprising a second mobile communication device in proximity to the electronic component, and wherein said first mobile communication device constitutes the device that paired first in time with the electronic component.

14. The method of claim 12 wherein the mobile communication device is a first mobile communication device in proximity to said electronic component, and further comprising a second mobile communication device in proximity to the electronic component, and wherein the electronic device determines the nearer one of the first and second mobile communication device in accordance with a received signal strength and is configured to pair with said nearer communication device.

15. The method of claim 3 wherein the transmitting of the request to the electronic component is performed by a safety monitoring application executing on the mobile communication device by writing a value to a subscribed service of the electronic component.

16. The method of claim 15 wherein receiving the request comprises determining when the value is written by the safety monitoring application to the service.

17. The method of claim 1 wherein the low level function of the mobile communication device comprises one of a device lock function, a HOME function, and a Power ON/OFF function.

18. A method of accessing a low level function on a mobile communication device, comprising:
defining an exclusionary zone having a physical extent;
defining predetermined criteria associated with the exclusionary zone as to when use of the mobile communication device by a user should be restricted;
pairing the mobile communication device with an electronic component in sensing proximity of the exclusionary zone;
determining, in the electronic component, when the predetermined criteria has been met; and
sending a command corresponding to one or more human interface device (HID) keypresses from the electronic component to the paired mobile communication device when the predetermined criteria has been satisfied, wherein the command is selected in accordance with a predetermined restriction strategy associated with the exclusionary zone.

19. A method of accessing a low level function on a mobile communication device, comprising:
defining an event zone having a physical extent associated with an event;
providing a monitoring application program to be installed on the mobile communication device wherein the application program has been given a plurality of permissions defining permitted use of features of the mobile communication device;
defining non-permitted uses of or actions with respect to the mobile communication device in the event zone;
sending, when the monitoring application program detects a non-permitted use or action, a request to the an electronic component to send a command to the mobile communication device configured to lock the device; and
sending the command to the mobile communication device to lock the device.

20. The method of claim 19 wherein sending the command comprises sending a command corresponding to one or more human interface device (HID) keypresses from the electronic component to the mobile communication device to thereby lock the mobile communication device.

21. A mobile communication device, comprising:
one or more processors;
a safety monitor application stored in memory for execution by the one or more processors configured to determine when predetermined vehicle information satisfy predetermined motion criteria and to transmit a request to an electronic component to send a command to the mobile communication device that is configured to lock the device;
an operating system interface stored in the memory for execution by the one or more processors configured to receive said command to lock the device and to thereby lock the device.
